(19) United States
(12) Patent Application Publication
(10) Pub. No.: US 2005/0053274 A1
(43) Pub. Date: Mar. 10, 2005

(54) System and method for 3D photography and/or analysis of 3D images and/or display of 3D images

(76) Inventors: Yaron Mayer, Jerusalem (IL); Haim Gadassi, Jerusalem (IL)

Correspondence Address: YARON MAYER, 21 AHAD HA'AM ST., JERUSALEM, 92151, IL

(21) Appl. No.: 10/827,912

(22) Filed: Apr. 19, 2004

(30) Foreign Application Priority Data
Apr. 21, 2003 (IL) 155525

(51) Int. Cl. G06K 9/00

(52) U.S. Cl. 382/154

(57) ABSTRACT

When 3D viewing means become much more available and common, it will be very sad that the many great movies that exist today will be able to be viewed in 3D only through limited and partial software attempts to recreate the 3D info. Films today are not filmed in 3D due to various problems, and mainly since a normal stereo camera could be very problematic when filming modern films, since for example it does not behave properly when zooming in or out is used, and it can cause many problems when filming for example smaller scale models for some special effects. For example, a larger zoom requires a correspondingly larger distance between the lenses, so that for example if a car is photographed at a zoom factor of 1:10, the correct right-left disparity will be achieved only if the lenses move to an inter-ocular distance of for example 65 cm instead of the normal 6.5 cm. The present invention tries to solve the above problems by using a 3D camera which can automatically adjust in a way that solves the zoom problem, and provides a solution also for filming smaller models. The angle between the two lenses is preferably changed according to the distance and position of the object that is at the center of focus, and changing the zoom affects automatically both the distance between the lenses and their angle, since changing merely the distance without changing the convergence angle would cause the two cameras to see completely different parts of the image. The patent also shows that similar methods can be used for example for a much better stereoscopic telescope with or without a varying zoom factor. In addition, the patent shows various ways to generate efficiently a 3D knowledge of the surrounding space, which can be used also for example in robots for various purposes, and also describes a few possible improvements in 3d viewing.

This Patent application claims priority from Israeli application 155525 of Apr. 21, 2003, hereby incorporated by reference in its entirety.

### BACKGROUND OF THE INVENTION

1. Field of the Invention

The present invention relates to 3D (three-dimensional) images, and more specifically to a system and method for 3D photography and/or analysis of 3D images and/or display of 3D images, for example for filming 3D movies of high quality or for allowing robots to have a better conception of their 3D surroundings.

2. Background

There have been many attempts in the prior art to create display methods for 3D still images or movies, and there have been stereoscopic cameras based on photographing or filming with two parallel lenses that are at approximately the same distance from each other as human eyes, so that a separate image for each eye can be captured. The two separate images can then be displayed each to the appropriate eye for example by using two separate polarizations and letting the viewer use polarized glasses (This is the best method for viewing 3D movies in a place where there are a lot of viewers, and has been used for example for displaying 3D movies in Russia), or letting the user wear glasses that project directly a different image for each eye (for example in virtual reality goggles) or for example letting the user wear glasses with fast LCD on-off flicker (used for example with some computer games, but this method can easily cause headache). A computer screen variation that works with wearing polarized glasses also exists, where the polarization of the pixels is typically in a checker-board fashion in order to prevent a sense of stripes. Other methods for 3D display currently in development that allow the users to view the 3D images without a need for special glasses (called autostereoscopic systems) are mainly lenticular element designs such as for example the Philips 3D LCD screen, based on creating a screen with a large number of vertical half-round transparent rods (Depending on the design, this can be used for example for a single-view—to transmit a pair of just two images, one for each eye, or for a multi-view of more than 2 pairs, which comes at the price of reducing the resolution and creating dark stripes, and also if the user moves the head sideways more than for example 7 cm, the viewing angle resets and starts rotating again), various parallax barrier designs (a pattern of vertical slits in front of the screen that limit the view of each pixel column to one eye), or micro-polarizer designs, which achieve results similar to the slit design but more flexibly. However, the various slit designs have the drawback of wasting most of the light, which is a significant problem when used with LCD screens (since the pixels transmit light in a wide angle and the slits typically are thinner than the blocking columns, and in LCD screens the level of light is much more limited than what is available in a CRT screen), and therefore in addition they can also create dark columns. The vertical half-round rods design has 2 other problems: It is difficult to coat the lenses with anti-reflection coating, which can lead to distracting reflections on the display surface, and the scattering of light in the lenses generates a visible artifact that looks to the user like a light-gray mist present throughout the 3D scene. Another variation for allowing to view the images from more than one angle of view is that instead of static multiview, there are better systems that use just 2 images and track the user's head movements and instantly change the image on the entire screen according to the appropriate angle, which can also give a much better illusion of a real multi-view angle of the 3D image, however these systems have the disadvantage that they can work for only one viewer at a time. Another problem of the above autostereoscopic systems is that moving the head half an inter-ocular distance (for example 3.2 cm) can cause the user to be in the wrong position where the right eye sees the left-eye-image and the left eye sees the right-eye-image (which is typically solved by giving a visual indication when the user is in the wrong right-left position), and being in-between in transition can create also a distorted view. Another problem is that such screens might be less convenient for example when the user wants to view a normal 2D display, for example when editing a Word document. A great review of such 3D display systems is given in a review by Dr. Nick Holliman, from the department of computer science at the University of Durham at http://www.dur.ac.uk/n.s.holliman/Presentations/3Dv3-0.pdf. Another very different approach is shown in U.S. Pat. No. 5,790,086, issued on Aug. 4, 1998 to Zelitt, which uses a screen where each pixel is displayed through an elongated lens (like multiple needles going into the screen) wherein the point of entry into the elongated lens changes the focal point, so that each pixel can be displayed as if it is originating from any desired depth. U.S. Pat. No. 6,437,920, issued on Aug. 20. 2002 to Wohlstadter, describes a similar principle, based on using polymer or liquid variable focus micro-lenses that change their shapes in response to an electrical potential. This approach has a great advantage that it avoids headaches that can happen in all the methods that broadcast two different images directly, one for each eye, since in all of these methods the illusion of depth is created by the disparity of the two images, but if the user tries to focus his eyes on a point that according to the illusion is at a certain depth, he will not see it properly since the depth where the real focus is does not fit the depth where the focus should be according to the illusion, and this is the main reason why this can cause headache after prolonged viewing. However, the last method is much more expensive, and on the other hand people can probably get used to not trying to change the focus even with two-images stereoscopic view—the same way that we are used to not try changing the focus according to perceived depth in a normal 2D film—since that would cause headache too if we tried for example to change the focus to far away when looking at a point that is supposed to be far away. Anyway, 3D viewing methods will probably continue to improve in the next few years and will probably become cheaper and more popular all the time.

The next problem then becomes how to create the images for these 3D displays. Of course, when computer programs or computer games are involved, the two separate sets of images can be created by the computer. However, when it comes to 3D movies, for example viewed from DVD on a computer screen, or viewed in a cinema, the problem is that there are currently practically no such available movies. Philips have tried to solve this program by creating a software that can automatically generate 3D images out of a normal DVD on the fly, using various cues and heuristics. However, any such attempts are limited by nature, since it would require a huge level of AI and knowledge about the world to do it well enough, and also, if for example a close object is filmed from the front where one side is a little more in view, the 3D extrapolation will still not be able to show part of the other side which would have been available if the object had been really filmed in 3D from a close enough point. Trying to reconstruct 3D images from a movie that has been filmed in 2D is like trying to add colors by computer to a black and white film—it might work partially, but a real color movie remains a much more rich experience. Similarly, when 3D viewing means become much more available and common for example through autostereoscopic 3D screens or through virtual reality goggles or with polarized glasses, it will be very sad that the many great movies that exist today will be able to be viewed in 3D only through limited and partial software attempts to recreate the 3D info. On the other hand, in practice films today are not filmed in 3D due to various problems, and mainly since a normal stereo camera could be very problematic when filming modern films, since for example it does not behave properly when zooming in or out is used (which is very important, since zooming ability is needed many times in filming situations, and is especially prevalent for example when music performances or music video-clips are filmed), and it can cause many problems when filming for example smaller scale models for some special effects. U.S. Pat. No. 4,418,993, issued on Dec. 6, 1983 to Lipton, shows various methods to correct deviations that can be created when changing zoom or focus, due to the fact that the 2 lenses can not be completely identical mechanically and optically. The needed corrections are computed for example by previously mapping the distortions in each of the two lenses, and the correction is done by small changes in the angle or distance of the lenses. U.S. Pat. No. 5,142,357, issued on Aug. 25, 1992 to Lipton et. al. discusses using computerized auto-feedback to correct such distortions. However, both of these patents apparently ignore the fact that a larger zoom requires a correspondingly larger distance between the lenses, so that for example if a car is photographed at a zoom factor of 1:10, for example so that a car 10 meters away seems to be only 1 meter away, the correct right-left disparity will be achieved only if the lenses move to an inter-ocular distance of for example 65 cm instead of the normal 6.5 cm. U.S. Pat. No. 6,414,709, issued on Jul. 2, 2002 to Palm et. al., discusses two cameras in which the distance between them changes automatically according to changes in the zoom and in the focus, however without changes in the angle between the two cameras, so that they remain substantially parallel all the time. This is due to their assumption that changing the angle will create also vertical parallax, so that if for example a small box is looked at from a close distance and the angle between the cameras is set to converge on the object, then the right camera will see the right margin of the object as higher and the left camera will see the left margin as higher. However, this is exactly what happens when humans or animals converge their eyes on a close object, so this distortion is exactly what should be expected. Therefore, the Palm et. al. patent has a number of applicability problems: 1. There is a confounding between changing focus and changing zoom factor, both affecting only the distance between the two camera lenses, whereas in reality the angle should be changed according to the distance and position of the object that is at the center of focus. 2. Changing zoom should affect automatically both the distance between the lenses and their angle, since changing merely the distance without changing the convergence angle will cause the two cameras to see completely different parts of the image. 3. The patent suggests using shifting of right and left images closer or farther from each other in the computer during the acquisition of the images or during display. But as will be shown below, merely shifting them while ignoring the depth of each pixel or each area will simply create a distorted result. The correct way is to use instead sophisticated interpolation for letting the computer simulate closer lenses and extrapolation to simulate farther lenses, as will be shown below in the present application. 4. The patent suggests that the separation between the two camera parts should be a function of the distance, whereas in reality, as will be shown below, the separation should be increased only if the zoom factor is increased. U.S. Pat. No. 6,512,892, issued on Jan. 28, 2003 to Montgomery at. al. of Sharp, Japan, discloses a 3D Camera in which the user changes manually the distance between the two lenses and the system automatically changes the zoom factor accordingly, also without changing the angle, so that the 2 cameras remain parallel. This is seemingly reversed compared to the Palm patent, and therefore less convenient, since normally the camera operator should worry about the zoom without having to think about the distance between the two cameras. But since the angle is not changed, this has the same problems. The sharp patent also refers to British patent 2,168,565 (equivalent to U.S. Pat. No. 4,751,570, issued on Jun. 14, 1988 to Robinson), which refers to adjustment according to zoom, focus, separation, and convergence, but does not indicate what relationship is obtained between these variables. In fact, the above patent states for example that it would be advantageous to increase the separation as the distance from the object becomes greater, however, as will be shown below, in reality the distance should be increased only if the zoom factor is increased. Similarly, the above patent has an embodiment where a single lens system is used with a number of rotating mirrors at fixed positions, thus ignoring again the need for being able to increase the separation between the two views if zoom is increased. On the other hand, the above patent mentions the possibility for using a projected laser light spot in order to help achieving a proper convergence between the two camera parts, which is good, except that this idea is not developed further, whereas as will be shown below, some additional problems have to be solved in order to make this practical.

Therefore, it would be very desirable to have a camera that can properly capture 3D films without the above problems, so that when future 3D viewing methods become more available, many 3D films that were originally filmed in 3D will be available. In addition, it would be desirable to improve 3D viewing systems in ways that solve the above described problems. Also, since computers or robots are still very limited in their ability to analyze visual information, various methods for knowing exactly the distance from each point in their surrounding space could also be very useful for them.

### SUMMARY OF THE INVENTION

The present invention tries to solve the above problems by using a 3D camera which can automatically adjust in a way that solves the zoom problem, and providing a solution also for filming smaller models. Similar methods can be used for example for a much better stereoscopic telescope with or without a varying zoom factor. In addition, the patent shows various ways to generate efficiently a 3D knowledge of the surrounding space, which can be used also for example in robots for various purposes.

The problem of creating a proper 3D camera is preferably solved in at least one of the following ways:
a. For solving the zoom problem, preferably the camera is based on two or more separate units (which can be for example two or three or more parts of the same camera, or 2 or for example 3 or more separate cameras), which are preferably coordinated exactly by computer control, so that each two (or more) frames are shot at the same time, and the focus changes and any movements of the two parts are well correlated. When using for example a 1:10 factor zoom, if for example a bottle that is at a distance of 10 meters is made to appear as if it is only 1 meter away, a normal stereo camera would perceive the image in a wrong way, since the distance between the two lens centers is only for example 6.5 cm (the average distance between the eyes), but at 10 meters away the difference between what the two lenses view is small, whereas at 1 meter away each lens would perceive more clearly a different angle of the bottle. In order to solve this problem correctly, when using the 1:10 zoom factor the lenses would have to be at a separation 10 times greater than normal, in order to simulate what would happen if the image was really 10 times closer. In other words, in this case the distance between the two lenses would have to be 65 cm instead of 6.5 cm. Therefore, preferably the two parts can automatically adjust the distance between them according to the zoom factor. This can be accomplished for example by mounting them on two preferably horizontal arms that rotate around a central point, for example like a giant scissors, as shown in FIG. 1b, or for example mounting the two parts on one or more sideways rods or tracks so that the distance between them can be increased or decreased by moving one or both of them on the rods or tracks, for example with a step motor and/or a voice coil (linear motor) or some combination of the two types of motors, as shown in FIG. 1a. Preferably the two (or more) cameras use automatic focusing (for example by laser measurement of the distance from the object that appears at the center of the lens), so that the camera operator preferably only has to worry about the zoom and the direction of the camera. Preferably the two (or more) parts or the two (or more) cameras are also able to automatically adjust the angle between them according to the distance from the object in focus, so that for example when viewing very close objects the angle between them becomes sharper. Of course, this is also needed if an automatic change of distance between the two parts during zoom is used, since otherwise the two parts would see non-converging images. On the other hand, with very close images that are later displayed to the user as jumping in front of the screen, the above mentioned vertical distortions created by the two cameras might be further increased if the eyes again try to converge on the illusion of the image. So another possible variation is that for very close images vertical size distortions are automatically fixed by an interpolation that makes the sides of the close object smaller, or for example for very close images the two lens converge only partially and the two image are brought closer by interpolation. Preferably everything or almost everything is automatic in the 3D camera, so the lenses preferably automatically find the distance to the target object preferably at the center of the image (or for example average distance or range of distances if the target is not a single spot at the middle), preferably by using for example laser or ultrasound or other known means for automatic finding of distances, automatically adjust the focus and the angle between them according to the distance, and if zoom is used then automatically the distance between the lenses is changed and their angle is also changed accordingly. This way the camera operator merely has to worry about what is in the frame and what zoom factor to use. Preferably the lenses are mechanically and optically the same as much as possible, and preferably computerized identification of the overlapping parts of the images is used to fix for example any minute errors in the convergence angle. Of course any distortions caused during changing zoom and/or focus caused by small mechanical and/or optical differences between the lenses are preferably fixed for example by the methods described by Lipton. (Another possible variation is, instead of or in addition to changing also the angle during zoom, using wider angle lenses or for example fish eye lenses and taking a different part of the image, but this is more expensive and more problematic since also a larger areas CCD is needed in that case and such lenses can cause various distortions). Preferably the auto-focus distance determination is done through infra-red laser, which has the advantage that it does not disturb the photographed people or animals and it can be detected by a preferably separate infrared-sensitive CCD, so that it does not add a visible mark to the image itself Preferably the laser mark is broadcast by an element positioned in the middle between the two lenses, and is detected for example by a sensor in the middle for finding the distance, and then preferably the two cameras or camera parts automatically also detect the laser mark and try to keep it preferably at the center of the image, thus helping further the adjustment of convergence based on auto-feedback. (Another possible variation is that the sensor in the middle is not needed and the infrared detectors coupled to one or two of the lenses are used also for determining the distance, but that might be less reliable if for example the lenses temporarily loose the alignment). Anyway, preferably the two lenses are converged in their angles so that the laser marks (from each of the two views) are not exactly on the same spot, but take into consideration the calculated parallax for that distance, since they are not supposed to be seen at the same point in both views unless the object in focus in very far away. Preferably this is done in combination with at least some additional digital processing or comparison of the two images (for example by comparing additional parts of the image) in order to further make sure that the convergence has been done correctly. This is important also since for example with very far images or with very irregularly shaped images at the focus the mark might become too spread or distorted to be useful. Another possible variation is to use for example more than one mark, for example one lower and one higher, in order to also help assure that the images are for example not tilted sideways (which can happen for example if the “scissors” method is used). Preferably the cameras are digital video cameras or the images are also digitized, so that computer analysis of the images can be used also for making sure the two cameras converge properly on the same image. On the other hand, movie producers still prefer today to use normal chemical films instead of video, because the result is still of higher quality. In order to solve this, preferably each or the two (or more) cameras has a resolution sufficiently large to compete with normal wide-screen film, and in addition preferably also the covering of colors is improved. As has been shown in PCT applications WO0195544 and WO02101644 by Genoa Color Technologies, the prior art RGB's ability to produce all the possible colors is only a myth, and in reality, although millions of color combinations can be displayed by the RGB method, they cover only combinations within a smaller triangle that represent only about 55% of the real triangle that represents the true number of color combinations that the human eye can see. The above two PCT applications describe various methods of correcting this in the display by translating the color combinations for display with 4 or more primary colors instead of the prior art 3 basic colors. However, the above applications ignore the possibility that a similar problem might exist when photographing or filming images with only 3 CCDs (one for each of the 3 primary colors), so that part of the color information is lost because it cannot be represented properly by only 3 primary color CCDs. Therefore, the cameras preferably each use 4 or more CCDs instead of 3, so that at least 4 (but preferably 5 or 6) primary color CCD's are used also during the capture of the images, and preferably the images are coded during the capture with 4 or more primary color codes instead of the normal 3. Preferably the optics is accordingly also improved so that the image is split among more than 3 types of CCDs. For example if a Yellow-sensitive CCD is added, this can be done for example by designing a CCD that is especially sensitive to the yellow range and/or using an appropriate yellow filter. Of course this can be done either when photographic directly into Video instead of on a chemical film, or for example when converting from chemical film to video. Of course similar methods can be used also with other light capturing devices that exist or might exists in the future instead of CCDs. Another possible variation is, in addition or instead, to increase or decrease for example the range of wavelengths sensitivity of each type of CCD, and/or for example to increase or decrease the wavelength differences between the primary color CCDs, for example as measured by the center of the range of each CCD. Of course, like other features of this invention, these features can be used also independently of any other features of this invention, including for example in any video or digital cameras or scanners that are not stereoscopic. Another possible variation is to use for example normal chemical films, but in addition automatically digitize the data for example at least in monochrome or also in color, in order to do for example the digital processing for ensuring correct convergence of the two cameras. However, if for example interpolation or extrapolation is used for producing the final image, then the entire film is preferably captured on digital video instead of normal chemical film. Another possible variation is that the computerized control for example senses and preferably corrects automatically any tilting of one or more of the cameras around a horizontal axis, so that either this is avoided, or the computer makes sure that if such tilting is desired in one camera then the horizontal tilting of the other camera will preferably be exactly the same or for example excess tilting can be corrected electronically. Since these processes are intended for use during zooming on-the-fly while filming, preferably the zooming process is electronically controlled through discrete steps, so that each time that a new frame is taken (for example at 30 frames per second), preferably the zooming stops temporarily, the distance between the lenses is automatically changed as needed, and the angle of convergence is automatically fixed by any of the above described methods, which can happen very fast with today's computation power of microprocessors, and only then the two images are taken (one or more frames, depending on the speed of the zoom), and then the process moves on to the next step. Similar methods can be used for example with large binoculars, for example with or without a variable zoom. If a variable zoom is used then it is preferably done similarly to the above described camera. However, since binoculars usually use a much larger enlargement factor than 1:10 but typically don't have a variable zoom, a more preferred variation is that the two parts are much further from each other and at a constant distance, for example at two corners of an observation post roof, so that for example if an enlargement of 1:100 is used, the two parts are 6.5 meters apart, and preferably only the angle between them changes automatically according to the focus. The 2 images are preferably transferred to small binocular lenses optically (for example like in a periscope) and/or electronically. This can give the viewer a much more real experience of viewing remote 3D object as if they are really very close, unlike a normal binocular telescope which gives an eerie flat view of remote objects due to the above-explained problem of using an inappropriate distance between the two lenses. Preferably the two remote lenses are also considerably bigger in this case—for example with a diameter of 20 cm or more each, so as to get a better quality image and lighting. If zoom is allowed with the binoculars, then either the two lenses can automatically move, or they stay at the same distance (or move only partially) and interpolation is used for simulating a closer distance (and/or extrapolation is used for simulating larger distances between the lenses), which would be similar to a morphing program, so that if for example they stay at the same distance and the zoom is decreased from 1:100 to 1:50, each displacement is preferably decreased by the same ratio, in this example two, and so for example pixels that were 2 cm apart will become 1 cm apart and pixels that were 3 mm apart will become 1.5 mm apart. The opposite extrapolation can be used for example in a home 3D video camera, that allows for example a zoom factor of up to 1:10, but it is undesired that the lenses can move apart up to 65 cm, unlike the above discussed movie camera. Therefore, preferably in such an amateur camera the lenses don't move apart or are limited for example to a smaller maximum separation, and the separation is done for example by computerized extrapolation of a simulated larger inter-lens distance or by a combination of real movement and additional extrapolation. (Another possible variation can be of course to limit the zoom factor is such home-use cameras to a smaller factor, for example to a factor of up to 1:3, and then for example the maximum separation between the centers of the two camera lenses is only about 20 cm, but that is less preferable). A similar solution can be used also in mobile convenient 3D binoculars where a large displacement between the two lenses is not desired, so, again, either extrapolation is used, or a combination of movement part of the way and extrapolation (which means that the image displayed to the user preferably appears on a computer-controlled screen or screens). When such a combination is used in a camera or in the binoculars it can be for example first use only the available physical displacement, and only if more displacement is needed than the automatic computerized displacement comes into action, or for example the extrapolation is activated at all the ranges except at minimum zoom, so that the user gets a smooth feeling of correlation between the physical movement of the two lenses and the actual zoom. This extrapolation can be done for example while capturing the images by one or more processors coupled to the cameras, or while displaying them. However if it is not done on the fly while filming, various parameters have to be saved together with the images such as for example at what distance and what zoom factor each set of images was taken, etc., and also the camera operator does not know how it will really look like, so it is more preferable to do it on the fly while filming, and of course in the case of the binoculars that use extrapolation this is the only available option. Preferably both the above described interpolation and extrapolation take into account also the expected effect of close objects hiding farther objects, so that when recalculating the image, when there is an overlap of positions, pixels with higher disparity that represent closer objects override pixels with less disparity that represent farther areas, as would occur in normal occlusion. However, since moving for example a closer pixel or part sideways can also reveal a part of a farther object that was previously hidden, such an extrapolation or interpolation preferably heuristically fills the newly exposed part for example by copying the nearest exposed pixels of the farther object, and/or for example by taking into account also information from the movement of the cameras and/or of the objects and/or of currently missing details that were revealed in previous frames. Another possible variation is that when the extrapolation or interpolation are used they take into consideration also the previous frames, so that for example a new calculation is done only for pixels that have changed from the previous frames. Although such an extrapolation will not really add for example more side-view, it can still give a good illusion of sufficient stereoscopic effect, and it can be considerably better than trying to convert a 2D DVD to 3D, since here the real depth data is available from the original disparity. Another possible variation is to add even new side-view details by guessing how the missing part should look like, for example by using AI that can identify standard objects, and/or for example by assuming symmetry of the two sides, and/or for example by using the info from the movement of the objects or of the camera, if such a movement previously revealed more information about the missing side-views, but that might be more complicated and less reliable. Another possible variation is to use for example 2 or more cameras at a constant preferably large distance between them which preferably is the maximum needed distance, for example 1 or 2 meters, and when they need to be closer, interpolation is used to create preferably by computer the correct views as if one or more of the cameras has been moved closer, for example like in the variation of the widely separated binoculars described above. This interpolation can be done for example while recording the image by one or more processors coupled to the cameras, or while displaying it, but again, it is more preferable to do it while recording. Another possible variation is to use for example 2 cameras at a constant preferably close distance and use 2 or more mirrors and/or prisms which are moved sideways and/or change their angles instead of moving the cameras. Another possible variation is that there are for example a number of mirrors at various fixed sideways positions and for each zoom an appropriate set of mirrors is put into action for example by rotating them into action, so that the zoom is available only in discrete steps. In the above variations if for example a third camera is used, it can be for example positioned in a way that creates a triangle (thus being able to add for example up-down disparity information) or for example positioned between the two cameras. If the intended display is multi-view (for example based on multi-view division of pixels or on updating the image as the user's head movement is tracked), then either for example more than 2 camera pairs are used, and/or for example 3 or more cameras are used so that the middle cameras can be paired with either the camera to their right or the camera to their left, and/or for example the cameras are arranged like on a round bow instead of on a straight line and/or for example interpolation is used to generate automatically by computer the changed angle of view, preferably in real time during the viewing, and/or for example multiple cameras are used for example in such a bow (for example 6-10 cameras on a bow of 1-2 meters, preferably with fixed distances between them), so that any two pairs can be automatically chosen depending on the desired distance and/or view angles. Of course, various combinations of the above and other variations can also be used.
b. Preferably for filming small models, a set of miniature lenses is used that can be brought together manually or automatically to a smaller distance that represents the scale, so that for example a model of 1:10 can be photographed by lens with a distance of 0.65 cm between them instead of for example 6.5 cm (like an ant for example sees something small as much bigger than it would seem to us). The images from the small lenses are preferably then enlarged optically and/or digitally and transferred to the two (or more) cameras or parts for processing. Another possible variation is using lenses with the normal separation (or for example a separation that is only partially smaller) and using interpolation for generating the image with smaller separation.
c. When CGI (Computer generated Images) are used, for example for special effects and/or for example for 3D animated films or computer generated sequences or for example 3D computer games, preferably two sets of images with the appropriate angle disparities according to depth are automatically created by the computer and are preferably fitted each with the appropriate set of filmed frames when needed.
d. For photographing images that are needed for computer analysis of the visual information or for viewing with a screen that uses a different focal distance for each pixel, preferably for each two (or more) images the image is digitized and a computer quickly analyses the degree of the disparity between each two corresponding points (or larger areas) in order to determine automatically the distance of that point (or area or object) from the set of cameras. This can be done for example in real time and transferred as an additional digital image or coding or matrix together with the real two (or more) images, or done later after the photography has taken place. If it is a film, then preferably either this analysis is done again for each frame, or for example the computer uses the info from the previous frames so that preferably the analysis of depth is done for example only for the pixels that have changed between the two frames. Even for a screen that uses a different focal point for each pixel preferably also the original two (or more) images for each frame are used, since otherwise there will still be the problem that viewing for example a supposedly closer image will still not reveal the appropriate side-views.
e. For robots that need to find their way in complex surroundings with better analysis of objects and distances around them a similar process for finding the distance to each point or area can be used, except that for example a number of camera pairs are preferably used simultaneously at different angles, or for example a set of two or for example 3 or more cameras preferably rotates quickly in a complete circle (or for example in a more limited range of angles, such as for example 180 degrees) in order to create a comprehensive representation of the distance from each point in a wide angle around the robot. This can be very useful, since unlike humans or animals, it is much harder to teach a computer or robot to automatically. focus on the more important or relevant stimuli and filter out or ignore the less important information from the surroundings. Another possible variation is to use for example a single camera that rotates preferably fast (for example 900 times per minute) for example on the edge of a rotating disk that rotates for example 30 times per minute, or for example limit the rotating of the camera and/or the disk to cover only some angles (both the disk and the camera preferably rotate horizontally around a vertical axis). The computer can then find for example the pairs of images where the central vertical stripe of pixels is the same and the angles of the two positions of the camera are symmetrical and thus determine the distance to each object around it according to the angle, as shown in FIG. 3. Another possible variation is to use for example any of the above configurations for generating stereoscopic panoramas that can be used for example for allowing the user to rotate the view in virtual reality while maintaining a stereoscopic view.
f. For efficient 3D viewing for example on computer screens, where there is typically a single user, an alternative that can solve the above described problems of the slit variations and of the half-round vertical rods variations, is to use, instead of the half rod elongated lenses, preferably elongated complex lenses which are for example wave shaped on the front, so that they direct the light from each pixel-column into the intermittent expanding stripes of light-dark more efficiently, so that the light in the blocked areas is not wasted but is added to the light in the lit areas. Of course the exact shape of each elongated lens is preferably different depending on its position, since for example the light from pixels that are in the middle of the screen has to be distributed evenly to both sides, whereas light from pixels at the side has to be distributed asymmetrically in order to create on-off stripes for light that comes from the side and reach the same on-off areas near the user. This can be accomplished for example by minute elongated lenses or Fresnel lenses, which are preferably manufactured for example by lithography as a transparent sheet which is coupled for example to an LCD screen or a CRT screen, as shown in FIG. 2a. Another possible variation is for example using elongated miniature triangles, preferably more than 1 per each pixel column, for example with techniques like in optic fibers, where the light is reflected internally by a core and a cladding that have a different optical refraction indexes, so that each pixel column is concentrated into the desired expanding on-off stripes of light-dark. Another possible variation is creating for example a system like the half-rods based display for multi-view, but using concave elongated mirrors instead of convex elongated lenses, which has the advantage of less problems of distortions and of reflections. Another possible variation is to use for example light-emitting nano-elements that come out of each pixel for example in the form of half a star, as shown in FIG. 2b. If the source of light is strong enough and the nano-elements are small enough this can solve the problem of sensing any dark stripes in the image. Another possible variation for example in LCD or CRT screens with parallax slits or the elongated half-rods or the elongated more complex lenses or mirrors is that head tracking is used also for determining if the user is in the correct right-left position, and if not then for example the image itself is instantly corrected by the computer for example by switching between all the left and right pixels or by moving the entire display left or right one pixel-column. Such a system is preferably used in combination with instantly updating the image's angle of viewing as the user moves sideways (this can be done for example if it is a computer-generated image or if it is for example still photo or a movie and additional angles of view have been filmed or can be interpolated or extrapolated for example from two or more filmed viewing angles). Another possible variation is that if this is used for example in combination with CRT screens, the image can be moved along with the user also for example in half-pixel steps or other fractions of a pixel, preferably in combination with a higher refresh rate of the screen (since moving in pixel fractions reduces the refresh rate), and thus even when the user is in an in-between position where each eye would view a mix of left and right images, and his head is tracked exactly, the image can be fitted again, thus giving the user more or less smooth view both when putting the eyes in the wrong left-right positions and when being in in-between states. Another possible variation is that when the user is in an in-between-state, for example piezo-electric elongated elements between the elongated lenses can move and/or rotate them a little in order to shift a little the position of the border between the right-left expanding stripes. Another possible variation is to use such movement or rotation for example by remote control if this is a 3d TV and the user wants to adjust the 3D view to appear properly at his current angle and distance from the TV. Another possible variation is that the image is viewed through a mirror for example at an angle of approximately 45 degrees, and tracking the user's head is used for changing the angle of the mirror as needed. This can be used for example in a configuration as shown in FIG. 2c. However, dealing with the in-between situation is less important since the problem occurs only in a small percent of the possible user positions. Although this is limited to a single user, this is not a big problem with computer screens since most of the time only one user views each screen. Another possible variation is that pre-distortions are automatically added to the images preferably by software, so that for example parts of the image that appear to jump out of the screen will look more sharp when in fact the user focuses his eyes on the illusory position of the object, and deeper objects that are seemingly more far away beyond the screen will appear sharper when the user actually tries to focus his eyes farther away. This is similar to displaying a distorted image on the screen that appears OK when a fitting distorting lens is added in front of the screen, except that in this case the changing lenses in the user's own eyes are taken into account as the distorting lenses. This is much cheaper than adding special hardware to create a different focal distance for each pixel. Another possible variation is to add more pixels, so that the pre-distortion is created by more than one pixel per actual pixel. Another possible variation is to add this pre-distortion only to images that are projected to appear jumping out of the screen, since these are the parts of the image where the user is most likely to try to focus his eyes differently than when looking at the screen. Of course, various combinations of the above and other variations can also be used.

### BRIEF DESCRIPTION OF THE DRAWINGS

FIGS. 1a-c are illustrations of a few preferable ways for automatically changing the distance and/or angles between the lenses of the two (or more) cameras.

FIGS. 2a-c are illustrations of a few preferable ways for further improving autostereoscopic displays.

FIG. 3 is a top-view illustration of a preferable example of using fast rotating one or more cameras to generate a map of the surroundings of a robot.

### IMPORTANT CLARIFICATION AND GLOSSARY

All the drawings are just or exemplary drawings. They should not be interpreted as literal positioning, shapes, angles, or sizes of the various elements. Throughout the patent whenever variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Although in most of the described variations the system is described as two cameras, this can be equivalently described as a single camera with two parts, and preferably the two cameras or parts are preferably as perfectly as possible coordinated electronically and/or mechanically. In addition, although in most of the variations the system has been described in reference to two cameras (or two camera parts), it should be kept in mind that more than two cameras or parts can also be used, for example all on the same vertical axis (so that more angles of view are available), or for example one or more of the cameras are on a separate vertical position, so that more information about the images can take into consideration also vertical parallax (However in that case the vertical parallax is preferably only used by the system and is not shown to the user, unless the user for example chooses to rotate the view). So throughout the patent, including the claims, two cameras or two camera parts can be used interchangibly, and can mean two or more cameras or camera parts.

### DETAILED DESCRIPTION OF THE PREFERRED EMBODIMENTS

All of descriptions in this and other sections are intended to be illustrative examples and not limiting.

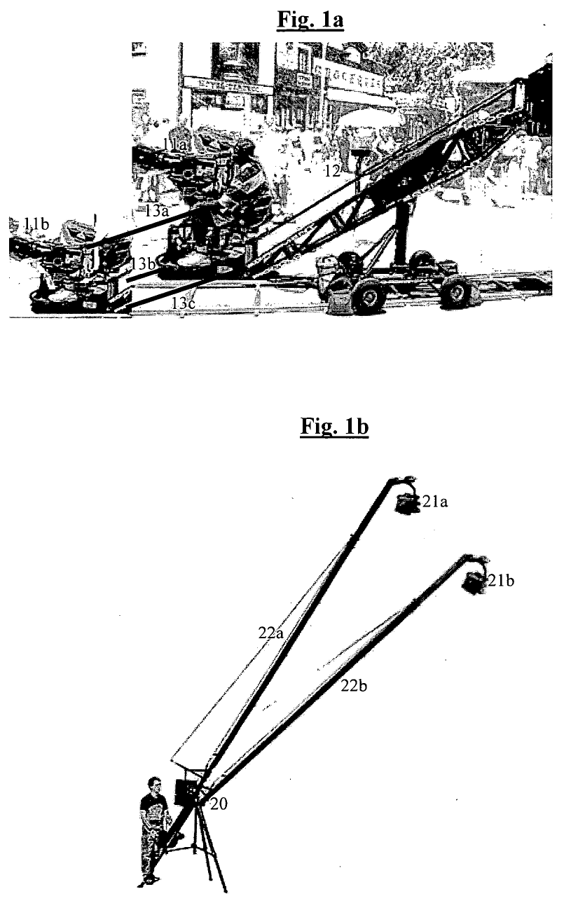

Referring to FIGS. 1a-c we show an illustration of a few preferable ways for automatically changing the distance and/or angles between the lenses of the two (or more) cameras. For solving the zoom problem, preferably the camera is based on two or more separate units (which can be for example two or three or more parts of the same camera, or 2 or 3 or more separate cameras), which are preferably coordinated exactly by computer control, so that each two (or more) frames are shot at the same time, and focus and/or zoom changes and/or any movements of the two parts are well correlated. So for example the operator can change the focus in one of the cameras for example by mechanical rotation or for example by moving an electronic control and preferably instantly the same movement or change is preferably electronically transferred also to the other camera or cameras. When using for example a 1:10 factor zoom, if for example a bottle that is at a distance of 10 meters is made to appear as if it is only 1 meter away, a normal stereo camera would perceive the image in a wrong way, since the distance between the two lens centers is only for example 6.5 cm (the average distance between the eyes), but at 10 meters away the difference between what the two lenses view is small, whereas at 1 meter away each lens would perceive more clearly a different angle of the bottle. In order to solve this problem correctly, when using the 1:10 zoom factor the lenses would have to be at a separation 10 times greater than normal, in order to simulate what would happen if the image was really 10 times closer. In other words, in this case the distance between the two lenses would have to be 0.65 meter instead of 6.5 cm. Therefore, preferably the two parts can automatically adjust the distance between them according to the zoom factor. This can be accomplished for example by mounting for example the two cameras (21a & 21b) on two preferably horizontal rods (22a & 22b) that rotate around a central point (20), for example like a giant scissors, as shown in FIG. 1b. This can be most relevant for example when using camera jibs for professional filming, however since jibs are used also for moving cameras up & down, preferably the scissor arms can be moved also up and down, preferably with complete correlation between the two arms. This has the advantage that the movement can be very fast, however the change in the direction where each part points to has to be corrected to account for the change caused by the rotation of the two horizontal arms, and also the movement is not linear, so that for example when the angle between the two arms is wider a smaller angle of rotation causes a larger change in the distance between the two parts. Therefore preferably near the central point or at some distance from it there is a very precise computer-controlled mechanism for correlating the sideways movements of the two arms and at the same time for example transferring electronic commands to the cameras to rotate so that they converge correctly. Another disadvantage of this method is that for example any vertical tremors in any of the “scissors” parts can cause problems of a shaking image and/or unwanted vertical parallax. Therefore, preferably the arms are stabilized as much as possible. Another possible variation is to add for example also for example one or more connecting rods, for further increasing the stability, or creating some combination with the configuration shown in FIG. 1a. Another problem is that the sideways movement of the “scissors” also changes the distance from each arm to the filmed object, which can be non-negligible if the object is not far enough, so preferably the new distance from each camera to the filmed object is also preferably automatically taken into account at each step. Another possible variation, shown in FIG. 1a, is mounting the two cameras or camera parts (11a & 11b) for example on one or more sideways rods (13a-c) and/or other type of tracks or extension so that the distance between the cameras can be increased or decreased by moving one or both of the cameras sideways. This can be more exact but it is harder to move as fast as the “scissors” method can move the two parts. However, this has the advantage of being much more stable, and the movement itself can be easily controlled for example by using one or more step motors or one or more voice-coils (linear motors) or for example a combination of the two types of motors, in order to reach preferably maximum speed and precision. Preferably both cameras move sideways towards each other or away from each other at the same time. Another possible variation to move just one camera and leave the other at a fixed position, but that is less desirable since that would create a side-effect that zooming causes also sideways shifting of the image and also some rotation (since this way only the angle of the moved camera would be changed to compensate for its sideways movement). This can be most useful for example in crane cameras so that for example the camera operator sits near the camera (11a) that is directly connected to the crane's arm (12), and the 2^{nd} camera (11b) is preferably electronically controlled to correlate as perfectly as possible with the first camera (11a). Preferably both cameras are connected to their bases over a vertical arm and the camera and/or the arm and/or part of the arm and/or another part can rotate in order to adjust the angle of convergence between the two cameras. Preferably at least the arm that supports camera 11b is shaped so that when moved closer the two cameras can reach a distance of 6.5 between the centers of their lenses even if the lower parts remain further apart so as not to disturb the camera operator. Another possible variation is to add, preferably in addition to the side extension, for example an additional crane arm to support more strongly camera 11b, so that the additional arm moves in synchrony with arm 12, but that could be much more expensive. Although camera 11b appears in this illustration to be somewhat lower than camera 11a, in reality of course the two cameras are preferably at the same vertical position. Preferably the cameras are digital video cameras or the images are also digitized, so that computer analysis of the images can be used also for making sure the two cameras converge properly on the same image, as explained above in the patent summary. Preferably the camera operator is shown for example through binoculars the correct 3D image, as transmitted by the computer. Another possible variation, shown in FIG. 1c, is to use a similar configuration also for example for jib cameras, so that there is only one arm (22) (or for example the one arm is composed of more than one rod, so that it is more stable) and at the end of it there is a structure (23) on which the two cameras (21a & 21b) are automatically moved sideways as needed (and of course their angle of convergence is also preferably changed automatically in accordance with the sideways movement). Preferably the two (or more) cameras use automatic focusing (for example by laser measurement of the distance from the object that appears at the center of the lens), so that the camera operator only has to worry about the zoom and the direction of the camera. Preferably the two (or more) parts or the two (or more) cameras are also able to automatically adjust the angle between them according to he distance from the object in focus, so that the for example when viewing very close objects the angle between them becomes sharper. Of course, this is also needed if an automatic change of distance between the two parts during zoom is used, since otherwise the two parts would see non-converging images. Also, since at a zoom factor of for example 1:10 any error in the angles becomes 10 times more pronounced, preferably the control of angles it very exact, for example with a fine step motor. The cameras themselves can be for example based on photographic film or based on preferably high-resolution video, but the 2^{nd} option is more preferable, since in that case the image can also be digitized and the computer can preferably also notice automatically if there is an error in the angles that causes lack of converging of the two images. Another possible variation is that the two images are transferred for example optically and/or electronically to a normal screen or to a stereo viewing station (for example binocular small lenses) so that the camera operator can see directly if there is any problem. Another possible variation is that the camera operator can for example deal with only one of the two parts (for example viewing only the view from the camera next to him) and the 2^{nd} part is automatically controlled by the computer to behave accordingly, or can for example choose between the two above variations. Preferably everything is automatically controlled by computer, so that when the user changes the zoom factor both the distance between the lenses and the angle between them are immediately adjusted accordingly in real time, and if the user changes the focus for example to or from very close object, the angle is preferably adjusted automatically in real time. If zoom out is used for example to a factor of half the normal view, then preferably the two lenses are moved closer to half the normal distance, for example 3.2 cm between their centers instead of 6.5. However, since such small distances between the two lens or two cameras might be impractical, preferably zoom out to less than normal view is not allowed, and also zoom-in is preferably only limited for example to a factor of 1:10 or for example 1:20 (or other reasonable factor) so that the maximum distance used is for example no more than 1 or 2 meters between the two parts at the maximum state. Another possible variation is that each camera has a small slit or uses other means to have a good focus at a large range of distances, so that preferably most of the image is in focus all the time, so that the user will have even less motivation to try to change the focus with his eyes when viewing the filmed scenes. Another possible variation is that the image is preferably always as much as possible in focus at least in the central areas of the frame, which also can reduce the chance that the user will unconsciously try to change the focus with his eyes. Of course, various combinations of the above and other variations can also be used.

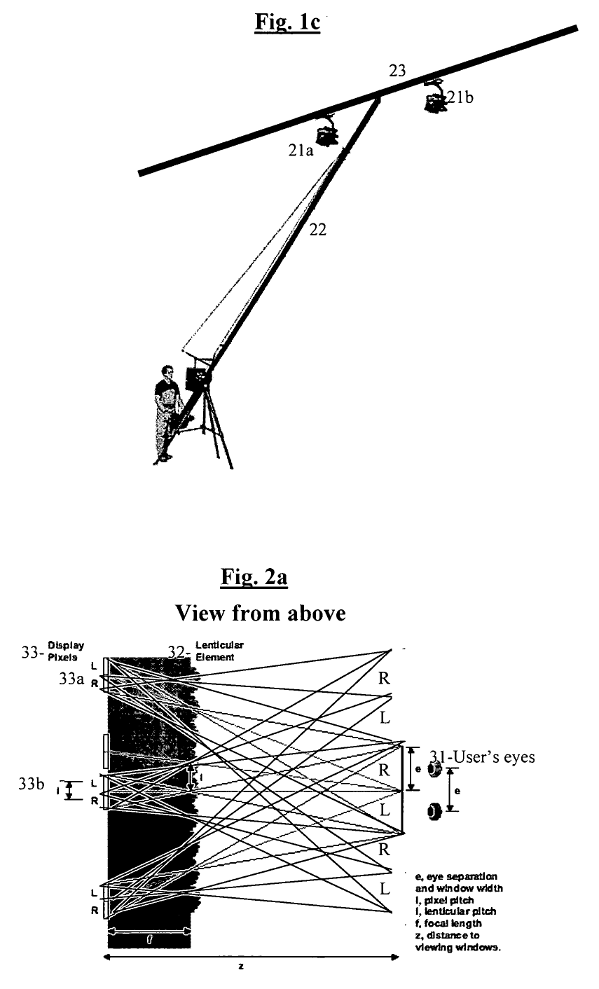

Referring to FIGS. 2a-c, we show illustrations of a few preferable ways for further improving autostereoscopic displays. For efficient 3D viewing for example on computer screens, where there is typically a single user, an alternative, shown at a top-view in FIG. 2a, that can solve the above described problems of the slit variations and of the half-round vertical rods variations, is to use, instead of the half rod elongated lenses, preferably elongated complex lenses which are for example wave shaped on the front (32), so that they direct the light from each pixel-column into the intermittent expanding stripes (Marked with R and L) of light-dark more efficiently, so that the light in the blocked areas is not wasted but is added to the light in the lit areas. Of course the exact shape of each elongated lens is preferably different depending on its position, since for example the light from pixels (33) that are in the middle of the screen (33b) has to be distributed evenly to both sides, whereas light from pixels at the side (33a) has to be distributed asymmetrically in order to create on-off stripes for light that come from the side and reach the same on-off areas near the user. This can be accomplished for example by minute elongated lenses or Fresnel lenses with the desired parameters, which are preferably manufactured for example by lithography as a transparent sheet which is coupled for example to an LCD screen or a CRT screen. Another possible variation is for example using elongated miniature triangles, preferably more than 1 per each pixel column, for example with techniques like in optic fibers, where the light is reflected internally by a core and a cladding that have a different optical refraction indexes, so that each pixel column is concentrated into the desired expanding on-off stripes of light-dark. Another possible variation is creating for example a system like the half-rods based display for multi-view, but using concave elongated mirrors instead of convex elongated lenses, which has the advantage of less problems of distortions and of reflections. Another possible variation, shown in FIG. 2b, is to use for example light-emitting nano-elements (41a . . . 41k and 42a . . . 42k) that come out of each pixel (41 and 42 in this example) for example in the form of half a star, so that in fact the pixel is composed of these light emitting elements. If the source of light is strong enough and the nano-elements are small enough this can solve the problem of sensing any dark stripes in the image. Another possible variation for example in LCD or CRT screens with parallax slits or the elongated half-rods or the elongated more complex lenses or mirrors is that head tracking is used also for determining if the user is in the correct right-left position, and if not then for example the image itself is instantly corrected by the computer for example by switching between all the left and right pixels or by moving the entire display left or right for example by one pixel-column. Such a system is preferably used in combination with instantly updating the image's angle of viewing as the user moves sideways (this can be done for example if it is a computer-generated image or if it is for example still photo or a movie and additional angles of view have been filmed or can be interpolated or extrapolated for example from two or more filmed viewing angles). Another possible variation is that if this is used for example in combination with CRT screens, the image can be moved along with the user also for example in half-pixel steps or other fractions of a pixel, preferably in combination with a higher refresh rate of the screen (since moving in pixel fractions reduces the refresh rate), and thus even when the user is in an in-between position where each eye would view a mix of left and right images, and his head is tracked exactly, the image can be fitted again, thus giving the user more or less smooth view both when putting the eyes in the wrong left-right positions and when being in in-between states. Another possible variation is that when the user is in an in-between-state, for example piezo-electric elongated elements between the elongated lenses can move or rotate the lenses a little in order to shift a little the position of the border between the right-left expanding stripes. Another possible variation is to use such movement or rotation for example by remote control if this is a 3d TV and the user wants to adjust the 3D view to appear properly at his current angle and distance from the TV. Another possible variation, shown in FIG. 2c, is that the image is viewed through a mirror (51) that reflects the display of a 3d preferably autostereoscopic screen (52)(Which can be for example a 3d LCD screen or a 3d plasma screen) for example at an angle of approximately 45 degrees, so that the front panel of the screen (53) is for example just a transparent glass, and tracking the user's head is used for changing the angle of the mirror as needed. However, this has the disadvantage of wasting a lot of room, so that even if a flat-type display is used, in practice the configuration takes the place of a typical CRT screen, but at least it can be much lighter than a similar sized CRT screen. Although this is limited to a single user, this is not a big problem for example with computer screens since most of the time only one user views each screen. Another possible variation is that pre-distortions are automatically added to the images, preferably by software, so that for example parts of the image that appear to jump out of the screen will look more sharp when in fact the user focuses his eyes on the illusory position of the object, and deeper objects that are seemingly more far away beyond the screen will appear sharper when the user actually tries to focus his eyes farther away. This is similar to displaying a distorted image on the screen that appears OK when a fitting distorting lens is added in front of the screen, except that in this case the changing lenses in the user's own eyes are taken into account as the distorting lenses. This is much cheaper than adding special hardware to create a different foal distance for each pixel. Another possible variation is to add more pixels, so that the pre-distortion is created by more than one pixel per actual pixel. Another possible variation is to add this pre-distortion only to images that are projected to appear jumping out of the screen, since these are the parts of the image where the user is most likely to try to focus his eyes differently than when looking at the screen. Another possible variation is to add for example eye tracking, so that for example this distortion is added automatically on the fly only if the user indeed tries to focus his eyes at the space in front of the screen, as can be determined for example by the angle of convergence between his/her eyes. Another possible variation is for example similarly to add an appropriate distortion of the fly also if the user for example tries to focus his eyes on an apparently far object. This can be another way for example to prevent the possible headache in prolonged viewing of stereoscopic images, which can be used for example with any of the 3d viewing methods. (The eye tracking can be done for example by the computer or TV screen itself or for example by other devices, so that for example if the user wears polarized glasses, the glasses themselves might for example broadcast the position or angles of the user's eyes to the screen for example wirelessly). Of course, various combinations of the above and other variations can also be used.

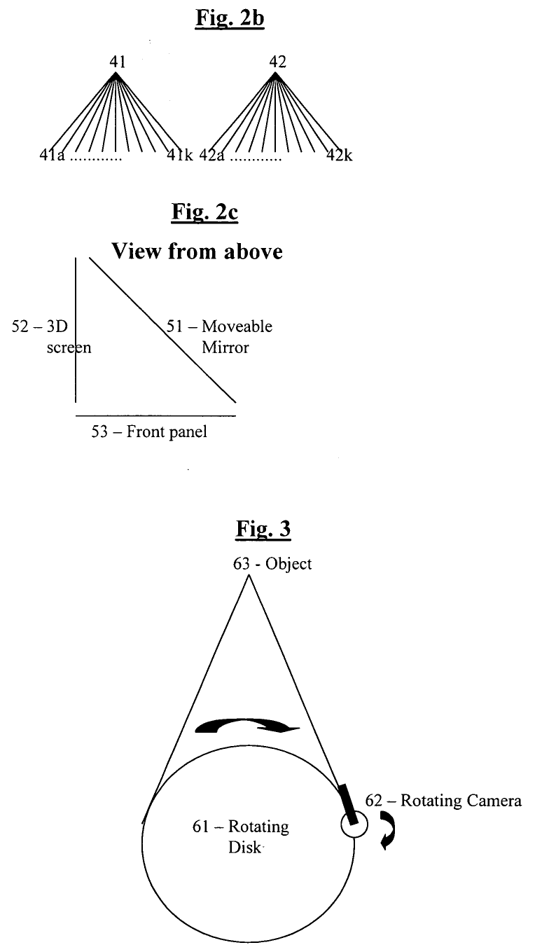

Referring to FIG. 3, we show a top-view illustration of a preferable example of using fast rotating one or more cameras to generate a map of the surroundings of a robot. In this example there a single camera (62) that rotates preferably fast (for example 900 times per minute, or any other convenient number) for example on the edge of a rotating disk (61) that rotates for example 30 times per minute (or any other convenient number), or for example the rotation of the camera and/or of the disk is limited to cover only some angles (both the disk and the camera preferably rotate horizontally around a vertical axis). The computer can then find for example the pairs of images where the central vertical stripe of pixels is the same and thus determine the distance to each object around it according to the angle of convergence that was between the two positions of the camera for the given pair. Of course this can be done also with more than one camera, but even one camera is enough. Preferably the system automatically senses and compensates for any tilting that can cause for example one side of the rotating disk to become lower than another side. The camera or cameras can be for example slit cameras that photograph only a central vertical stripe in the middle of their view. Another possible variation is to put for example a fixed camera at the middle of the rotating disk that so that the camera rotates only together with the disk, and the camera points for example at a rotating mirror at an edge of the disk. Another possible variation is to use for example, instead of a camera or a mirror, a preferably rotating laser transmitter and sensor at the edge of the disk, so that that at each position preferably the laser runs a fast sweep for example up and down (and/or in other desired directions) and so the distance to the preferably vertical scan line can be measured this way actively and even more precisely. Another possible variation is to put the laser transmitter and sensor for example on a rotating preferably vertical pole without the disk at all, which also creates an estimate of distances all around, but the configuration where the laser transmitter and sensor are rotating at the end of the rotating disk gives even additional info. Another possible variation is to use for example more than one laser transmitter and receiver pair simultaneously. Of course the disk is just an example, and other shapes could also be used, such as for example a rotating ring or other desired shapes. Of course various combinations of the above and other variations can also be used.

While the invention has been described with respect to a limited number of embodiments, it will be appreciated that many variations, modifications, expansions and other applications of the invention may be made which are included within the scope of the present invention, as would be obvious to those skilled in the art.

1. A system for obtaining 3D images, using at least two cameras or camera parts or binoculars, which automatically takes care of achieving proper stereo separation according to distance and zoom, comprising at least one of:
a. A system for automatically increasing the separation between the two cameras or binocular lenses by the factor of the zoom, while at the same time changing the angle of conversion so that the cameras still converge correctly on the same frame of view.
b. A system for automatic computerized extrapolation of the proper parallax between the two views, so that for increasing the zoom the two cameras or binocular lenses are moved apart only part of the needed distance or not moved at all, and the computer uses the parallax information from the real two images in order to extrapolate the enlarged parallax that should be achieved, while taking into account the estimated distances.
c. A system for automatic computerized interpolation of the proper parallax between the two views, so that for reducing the zoom the two cameras or binocular lenses are kept at a larger separation, and the computer uses the parallax information from the real two images in order to interpolate the reduced parallax that should be achieved, while taking into account the estimated distances.

2. The system of claim 1 wherein said extrapolation takes into account also the calculated distances for calculating the proper occlusion, so that at least one of:
a. When there is overlap of positions closer pixels override farther pixels.
b. If moving a closer part sideways reveals a part of a farther object that was previously hidden, the newly exposed part is extrapolated by at least one of: Copying the nearest exposed pixels of the farther object, and Taking into account also information from the movement of the cameras and/or of the objects.

3. The system of claim 1 wherein the two cameras or camera parts are moved sideways in relation to each other and at least one of the following features exists:
a. They are mounted on arms that rotate around a central point and the angels of conversion are automatically adjusted to take into account also the rotation caused by the rotation of the arms, so that at least one of the arms moves.
b. They move sideways on at least one rod and/or tracks and/or extension, so that the distance between them can be increased or decreased by moving one or both of them on the rods or tracks or extension.
c. The sideways movement is achieved by at least one of a step motor and a voice coil (linear motor).

4. The system of claim 1 wherein at least one of the following features exists:
a. The two cameras or camera parts are adapted to automatically adjust the angle between them according to the distance from the object in focus.
b. For very close images at least one of the following is done: 1. Vertical size distortions are automatically fixed by an interpolation that makes the sides of the close object smaller, and 2. The two lens converge only partially and the two image are brought closer by interpolation in away similar to the way the extrapolation is computed.
c. The system automatically finds the distance to the target object by at least one of laser, ultrasound, and other known means for finding distances, automatically adjusts the focus and the angle between the lenses according to the distance, and if zoom is used than automatically the distance between the lenses is changed and their angle is also changed again accordingly.
d. The system automatically finds the distance to the target object by at laser, and said laser is an infrared laser, so that it does not disturb the photographed people or animals and does not add a visible mark to the image itself, and at least one laser mark is used, and the two cameras or camera parts automatically also detect the at least one laser mark and use it to help the adjustment of convergence based on auto-feedback, while taking into account the expected parallax of the laser mark, based on the distance.
e. At least some additional digital comparison of the two images is done in order to further make sure that the convergence has been done correctly.
f. The zooming process is electronically controlled through discrete steps, so that each time that a new frame is taken, the zooming stops temporarily, the angle of convergence is automatically fixed, and only then the two images are taken, and then the process moves on to the next step.
g. A combination of extrapolation with actual displacement is used for increasing the zoom and at least one of: 1. First only the available physical displacement is used, and only if more displacement is needed than the automatic computerized displacement comes in-to action. 2. The extrapolation is activated at all the ranges except at minimum zoom, so that the user gets a smooth feeling of correlation between the physical movement of the two lenses and the actual zoom.
h. The interpolation or extrapolation are done at least one of: 1. While capturing the images by one or more processors coupled to the cameras, and 2. While displaying them, and parameters such as the zoom factor are saved together with the images for the later processing.
i. The extrapolation and/or the interpolation take into consideration also the previous frames, so that a new calculation is done only for pixels that have changed from the previous frames.
j. At least two mirrors and/or prisms are moved sideways and/or change their angles instead of moving the cameras.
k. For filming small models at least one of the following is done: 1. A set of miniature lenses is used that can be brought together manually to a smaller distance that represents the scale. 2. The lenses remain with the normal separation or with a separation that is only partially smaller than normal, and interpolation is used for generating the image with smaller separation.
l. When CGI (Computer generated Images) are used for special effects, two sets of images with the appropriate angle disparities according to depth are automatically created by the computer and fitted each with the appropriate set of filmed frames.

5. The system of claim 1 wherein for a screen that uses a different focal point for each pixel also the original two (or more) images for each frame are used, so that the appropriate side-views are available.

6. (Canceled).

7. (Canceled).

8. The system of claim 1 wherein for improved autostereoscopic 3D viewing at least one of:
a. Elongated complex lenses are coupled to a display screen, so that they direct the light from each pixel-column into intermittent expanding stripes of light-dark more efficiently, so that the light in the blocked areas is not wasted but is added to the light in the lit areas.
b. Elongated miniature triangles, more than one per each pixel column, are used, with techniques like in optic fibers, where the light is reflected internally by a core and a cladding that have in different optical refraction indexes, so that each pixel column is concentrated into the desired expanding on-off stripes of light-dark.
c. Light-emitting nano-elements are used that come out of each pixel in many directions.
d. Head tracking is used for determining if the user is in the correct right-left position, and if not then the image itself is instantly corrected by the computer by at least one of: Switching between all the left and right pixels, and Moving the entire display left or right one pixel-column.
e. When the user is in an in-between position where each eye would view a mix of left and right images, the image can be moved along with the user also in half-pixel steps or other fractions of a pixel,
f. When the user is in an in-between-state, the elongated lenses can be moved and/or rotated a little in order to shift a little the position of the border between the right-left expanding stripes.
g. Pre-distortions are automatically added to the images, so that at least parts of the image that appear to jump out of the screen and/or images that appear to be far away will look more sharp when in fact the user focuses his eyes on the illusory position of the object.
h. Pre-distortions can be automatically added to the images on the fly, according to eye tracking that determines where the user is currently trying to focus his eyes, so that at least parts of the image that appear to jump out of the screen and/or images that appear to be far away will look more sharp when in fact the user focuses his eyes on the illusory position of the object.

9. The system of claim 8 wherein said elongated lenses are at least one of:
a. Wavy shaped elongated lenses.
b. Fresnel lenses with the desired parameters.

10. The system of claim 3 wherein at least one of the following features exist:
a. The cameras or camera parts are mounted on jibs, so that two arms are used, one for each camera.
b. The cameras or camera parts are mounted on the same jib, so that at the end of the jib there is an extension on which the cameras can move sideways.
c. The cameras or camera parts are mounted on a crane, so that at one camera is connected directly to the crane's arm, and the other camera is connected to a sideways extension with which the cameras can be moved sideways, with or without an additional crane arm for the second camera.
d. The camera operator is shown through binoculars the correct 3D image, as transmitted by the computer.
e. Each camera has a small slit or uses other means to have a good focus at a large range of distances, so at least most of the image or the central part of the image is in focus all the time, so that the user will have less motivation to try to change the focus with his eyes when viewing the filmed scenes.

11. A method for obtaining 3D images, using at least two cameras or camera parts or binoculars, which automatically takes care of achieving proper stereo separation according to distance and zoom, comprising at least one of the following steps:
a. Using a system for automatically increasing the separation between the two cameras or binocular lenses by the factor of the zoom, while at the same time changing the angle of conversion so that the cameras still converge correctly on the same frame of view.
b. Using a system for automatic computerized extrapolation of the proper parallax between the two views, so that for increasing the zoom the two cameras or binocular lenses are moved apart only part of the needed distance or not moved at all, and the computer uses the parallax information from the real two images in order to extrapolate the enlarged parallax that should be achieved, while taking into account the estimated distances.
c. Using a system for automatic computerized interpolation of the proper parallax between the two views, so that for reducing the zoom the two cameras or binocular lenses are kept at a larger separation, and the computer uses the parallax information from the real two images in order to interpolate the reduced parallax that should be achieved, while taking into account the estimated distances.

12. The method of claim 11 wherein said extrapolation takes into account also the calculated distances for calculating the proper occlusion, so that at least one of:
a. When there is overlap of positions closer pixels override farther pixels.
b. If moving a closer part sideways reveals a part of a farther object that was previously hidden, the newly exposed part is extrapolated by at least one of: Copying the nearest exposed pixels of the farther object, and Taking into account also information from the movement of the cameras and/or of the objects.

13. The method of claim 11 wherein the two cameras or camera parts are moved sideways in relation to each other and at least one of the following features exists:
a. They are mounted on arms that rotate around a central point and the angels of conversion are automatically adjusted to take into account also the rotation caused by the rotation of the arms, so that at least one of the arms moves.
b. They move sideways on at least one rod and/or tracks and/or extension, so that the distance between them can be increased or decreased by moving one or both of them on the rods or tracks or extension.
c. The sideways movement is achieved by at least one of a step motor and a voice coil (linear motor).

14. The method of claim 11 wherein at least one of the following features exists:
a. The two cameras or camera parts are adapted to automatically adjust the angle between them according to the distance from the object in focus.
b. For very close images at least one of the following is done: 1. Vertical size distortions are automatically fixed by an interpolation that makes the sides of the close object smaller, and 2. The two lens converge only partially and the two image are brought closer by interpolation in away similar to the way the extrapolation is computed.
c. The system automatically finds the distance to the target object by at least one of laser, ultrasound, and other known means for finding distances, automatically adjusts the focus and the angle between the lenses according to the distance, and if zoom is used than automatically the distance between the lenses is changed and their angle is also changed again accordingly.
d. The system automatically finds the distance to the target object by at laser, and said laser is an infrared laser, so that it does not disturb the photographed people or animals and does not add a visible mark to the image itself, and at least one laser mark is used, and the two cameras or camera parts automatically also detect the at least one laser mark and use it to help the adjustment of convergence based on auto-feedback, while taking into account the expected parallax of the laser mark, based on the distance.
e. At least some additional digital comparison of the two images is done in order to further make sure that the convergence has been done correctly.
f. The zooming process is electronically controlled through discrete steps, so that each time that a new frame is taken, the zooming stops temporarily, the angle of convergence is automatically fixed, and only then the two images are taken, and then the process moves on to the next step.
g. A combination of extrapolation with actual displacement is used for increasing the zoom and at least one of: 1. First only the available physical displacement is used, and only if more displacement is needed than the automatic computerized displacement comes in-to action. 2. The extrapolation is activated at all the ranges except at minimum zoom, so that the user gets a smooth feeling of correlation between the physical movement of the two lenses and the actual zoom.
h. The interpolation or extrapolation are done at least one of: 1. While capturing the images by one or more processors coupled to the cameras, and 2. While displaying them, and parameters such as the zoom factor are saved together with the images for the later processing.
i. The extrapolation and/or the interpolation take into consideration also the previous frames, so that a new calculation is done only for pixels that have changed from the previous frames.
j. At least two mirrors and/or prisms are moved sideways and/or change their angles instead of moving the cameras.
k. For filming small models at least one of the following is done: 1. A set of miniature lenses is used that can be brought together manually to a smaller distance that represents the scale. 2. The lenses remain with the normal separation or with a separation that is only partially smaller than normal, and interpolation is used for generating the image with smaller separation.
l. When CGI (Computer generated Images) are used for special effects, two sets of images with the appropriate angle disparities according to depth are automatically created by the computer and fitted each with the appropriate set of filmed frames.

15. The method of claim 11 wherein for a screen that uses a different focal point for each pixel also the original two (or more) images for each frame are used, so that the appropriate side-views are available.

16. (Canceled).

17. (Canceled).

18. The method of claim 11 wherein for improved autostereoscopic 3D viewing at least one of:
a. Elongated complex lenses are coupled to a display screen, so that they direct the light from each pixel-column into intermittent expanding stripes of light-dark more efficiently, so that the light in the blocked areas is not wasted but is added to the light in the lit areas.
b. Elongated miniature triangles, more than one per each pixel column, are used, with techniques like in optic fibers, where the light is reflected internally by a core and a cladding that have a different optical refraction indexes, so that each pixel column is concentrated into the desired expanding on-off stripes of light-dark.
c. Light-emitting nano-elements are used that come out of each pixel in many directions.
d. Head tracking is used for determining if the user is in the correct right-left position, and if not then the image itself is instantly corrected by the computer by at least one of Switching between all the left and right pixels, and Moving the entire display left or right one pixel-column.
e. When the user is in an in-between position where each eye would view a mix of left and right images, the image can be moved along with the user also in half-pixel steps or other fractions of a pixel,
f. When the user is in an in-between-state, the elongated lenses can be moved and/or rotated a little in order to shift a little the position of the border between the right-left expanding stripes.
g. Pre-distortions are automatically added to the images, so that at least parts of the image that appear to jump out of the screen and/or images that appear to be far away will look more sharp when in fact the user focuses his eyes on the illusory position of the object.
h. Pre-distortions can be automatically added to the images on the fly, according to eye tracking that determines where the user is currently trying to focus his eyes, so that at least parts of the image that appear to jump out of the screen and/or images that appear to be far away will look more sharp when in fact the user focuses his eyes on the illusory position of the object.

19. The method of claim 18 wherein said elongated lenses are at least one of:
a. Wavy shaped elongated lenses.
b. Fresnel lenses with the desired parameters.

20. The method of claim 13 wherein at least one of the following features exist:
a. The cameras or camera parts are mounted on jibs, so that two arms are used, one for each camera.
b. The cameras or camera parts are mounted on the same jib, so that at the end of the jib there is an extension on which the cameras can move sideways.
c. The cameras or camera parts are mounted on a crane, so that at one camera is connected directly to the crane's arm, and the other camera is connected to a sideways extension with which the cameras can be moved sideways, with or without an additional crane arm for the second camera.
d. The camera operator is shown through binoculars the correct 3D image, as transmitted by the computer.
e. Each camera has a small slit or uses other means to have a good focus at a large range of distances, so at least most of the image or the central part of the image is in focus all the time, so that the user will have less motivation to try to change the focus with his eyes when viewing the filmed scenes.

21. A method for increasing the color information and/or the number of capture-able color combinations during capturing of images, comprising at least one of the following steps:
a. Using at least 4 or more different primary color CCDs during the capture of the images.
b. Coding the images during the capture with 4 or more primary color codes instead of the normal 3.
c. Using a video capture system wherein the range of wavelengths sensitivity of each type of CCD is substantially higher or lower than normal.
d. Using a video capture system wherein the wavelength difference between the different primary color CCDs is substantially larger or substantially smaller than normal.

22. The method of claim 11 wherein for increasing the color information and/or the number of capture-able color combinations during capturing of images, at least one of the following steps are used:
a. Using at least 4 or more different primary color CCDs during the capture of the images.
b. Coding the images during the capture with 4 or more primary color codes instead of the normal 3.
c. Using a video capture system wherein the range of wavelengths sensitivity of each type of CCD is substantially higher or lower than normal.
d. Using a video capture system wherein the wavelength difference between the different primary color CCDs is substantially larger or substantially smaller than normal.
